(19) United States
(12) Patent Application Publication
(10) Pub. No.: US 2017/0022839 A1
(43) Pub. Date: Jan. 26, 2017

(54) GAS TURBINE ENGINE COMPONENT MATEFACE SURFACES

(71) Applicant: United Technologies Corporation, Farmington, CT (US)

(72) Inventors: Scott D. Lewis, Vernon, CT (US); Atul Kohli, Tolland, CT (US); Thomas J. Praisner, Colchester, CT (US)

(21) Appl. No.: 15/039,945

(22) PCT Filed: Nov. 13, 2014
(86) PCT No.: PCT/US2014/065430

§ 371 Date: May 27, 2016

Related U.S. Application Data
(60) Provisional application No. 61/913,483, filed on Dec. 9, 2013.

(51) Int. Cl. F01D 11/08; F01D 9/02; F01D 5/12

(52) U.S. Cl. CPC F01D 11/08; F01D 5/12; F01D 9/02; F05D 2220/32; F05D 2240/80

(57) ABSTRACT

An array of components in a gas turbine engine includes first and second structures respectively including first and second surfaces that are arranged adjacent to one another to provide a gap. The first and second surfaces respectively have first and second rounded edges at the gap that are arranged in staggered relationship relative to one another.

### CROSS-REFERENCE TO RELATED APPLICATIONS

This application claims priority to U.S. Provisional Application No. 61/913,483, which was filed on Dec. 9, 2013 and is incorporated herein by reference.

### BACKGROUND

This disclosure relates to gas turbine engine component matefaces of adjacent structures.

A gas turbine engine uses a compressor section that compresses air. The compressed air is provided to a combustor section where the compressed air and fuel is mixed and burned. The hot combustion gases pass over a turbine section to provide work that may be used for thrust or driving another system component.

Turbine blades, vanes, and BOAS are arranged in circumferential arrays in gas turbine engines such that the endwalls of adjoining structures are adjacent to one another. The adjacent endwalls provide a gap between the structures. Typically matefaces are provided with sharp angled transitions with the gaspath surfaces.

The structures are manufactured and accepted for use based on their blueprint tolerance limits. These limits are typically made as wide as possible by engineering in order to minimize costly scrap. Wide tolerance limits can result in blades, vanes, and BOAS to be placed next to one another that have significant endwall misalignment in the radial direction across the mateface gap.

Radial misalignment can cause an air dam or waterfall when the downstream gaspath surface is radially misaligned with the upstream gaspath surface. This misalignment creates undesirable aerodynamic losses as well as undesirable high gaspath heat transfer coefficients. High heat transfer coefficients occur where the gaspath air impinges on the opposing mateface. The misalignment causes a separation zone on the downstream gaspath surface as the air is forced into the mateface gap. Downstream of the separation zone, the gaspath air reattaches to the endwall surface which causes another undesirable area of high heat transfer coefficient.

### SUMMARY

In one exemplary embodiment, an array of components in a gas turbine engine includes first and second structures respectively including first and second surfaces that are arranged adjacent to one another to provide a gap. The first and second surfaces respectively have first and second rounded edges at the gap that are arranged in staggered relationship relative to one another.

In a further embodiment of the above, the gap is provided at a constant angle along a generally axial length from a forward end of the first and second structures to an aft end of the first and second structures.

In a further embodiment of any of the above, the axial length includes first and second lengths. The first and second lengths are each in a range of 30-70% of the axial length. The first rounded edge is arranged along the first length. The second rounded edge is arranged along the second length.

In a further embodiment of any of the above, the first and second structures respectively include first and second matefaces facing one another at the gap. The first and second surfaces form generally sharp corners respectively with the first and second matefaces adjacent to the first and second rounded edges, respectively.

In a further embodiment of any of the above, the first and second surface and the first and second matefaces are respectively perpendicular to one another.

In a further embodiment of any of the above, the first and second structures are one of a blade outer air seal or a platform.

In a further embodiment of any of the above, the first and second structures are one of a stator vane or blade. An airfoil extends radially from each of the first and second surfaces. Each of the airfoils includes pressure and suction sides joined at leading and trailing edges.

In a further embodiment of any of the above, the first rounded edge is on a forward portion of the first surface near the leading edge and the pressure side. The first surface includes a generally sharp corner on an aft portion of the first surface near the trailing edge and the pressure side.

In a further embodiment of any of the above, the second rounded edge is on an aft portion of the second surface near the trailing edge and the suction side. The second surface includes a generally sharp corner on a forward portion of the second surface near the leading edge and the suction side.

In a further embodiment of any of the above, a flow path is configured to be provided between the airfoils. The flow path is configured to provide a first flow into the first rounded edge and a second flow into the second rounded edge.

In a further embodiment of any of the above, the first and second surfaces are misaligned with one another in the radial direction.

In another exemplary embodiment, a component in a gas turbine engine includes a structure that has a surface with a generally linear lateral edge. The lateral edge has a rounded edge along a first portion and a generally sharp corner along a second portion adjacent to the first portion.

In a further embodiment of the above, the structure is one of a blade outer air seal or a platform.

In a further embodiment of any of the above, the structure is one of a stator vane or blade. An airfoil extends radially from the surface. The airfoil includes pressure and suction sides joined at leading and trailing edges.

In a further embodiment of any of the above, the rounded edge is on a forward portion of the surface near the leading edge and the pressure side, and the surface includes a generally sharp corner on an aft portion of the surface near the trailing edge and the pressure side.

In a further embodiment of any of the above, the rounded edge is on an aft portion of the surface near the trailing edge and the suction side. The surface includes a generally sharp corner on a forward portion of the surface near the leading edge and the suction side.

In a further embodiment of any of the above, a first rounded edge is on a forward portion of the surface near the leading edge and the pressure side. The surface includes a generally sharp corner on an aft portion of the surface near the trailing edge and the pressure side. A second rounded edge is on an aft portion of the surface near the trailing edge and the suction side. The surface includes a generally sharp corner on a forward portion of the surface near the leading edge and the suction side and comprising a flow path that is configured to be provided on the surface. The flow path is configured to provide a first flow into the first rounded edge and a second flow into the second rounded edge.

In a further embodiment of any of the above, the structure includes matefaces transverse to the surface to provide the rounded edge and forming a sharp corner adjacent to the rounded edge.

In a further embodiment of any of the above, the surface and the mateface are perpendicular to one another.

### BRIEF DESCRIPTION OF THE DRAWINGS

The disclosure can be further understood by reference to the following detailed description when considered in connection with the accompanying drawings wherein:

FIG. 1 is a highly schematic view of an example gas turbine engine.

FIG. 2A is a schematic view of an array of blade outer air seals.

FIG. 2B is a schematic view of a single stator vane.

FIG. 2C is a schematic view of a doublet stator vane.

FIG. 3A is a perspective view of the airfoil having the disclosed cooling passage.

FIG. 3B is a plan view of the airfoil illustrating directional references.

FIG. 4 is an elevational view of adjacent turbine blades.

FIG. 5A is a cross-sectional view through the turbine blades along line 5A-5A of FIG. 4.

FIG. 5B is a cross-sectional view of the turbine blades along line 5B-5B in FIG. 4.

FIG. 6 is an enlarged cross-sectional view similar to that shown in FIG. 5B with the turbine blade platforms misaligned.

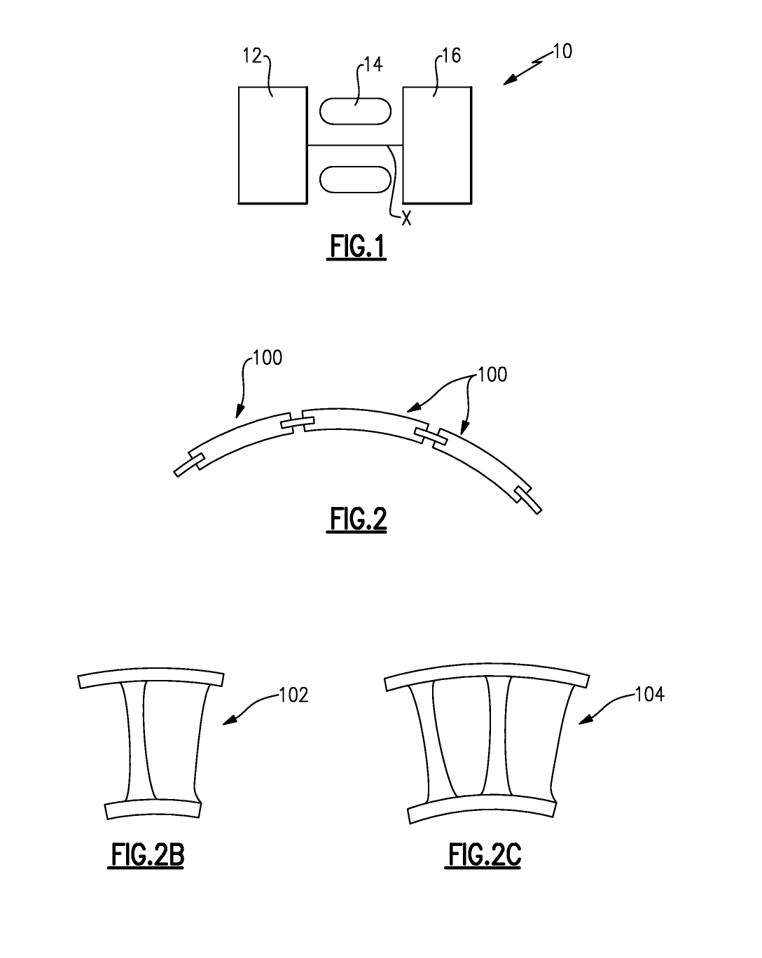

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

The disclosed cooling configuration may be used in various gas turbine engine applications. A gas turbine engine 10 uses a compressor section 12 that compresses air. The compressed air is provided to a combustor section 14 where the compressed air and fuel is mixed and burned. The hot combustion gases pass over a turbine section 16, which is rotatable about an axis X with the compressor section 12, to provide work that may be used for thrust or driving another system component.

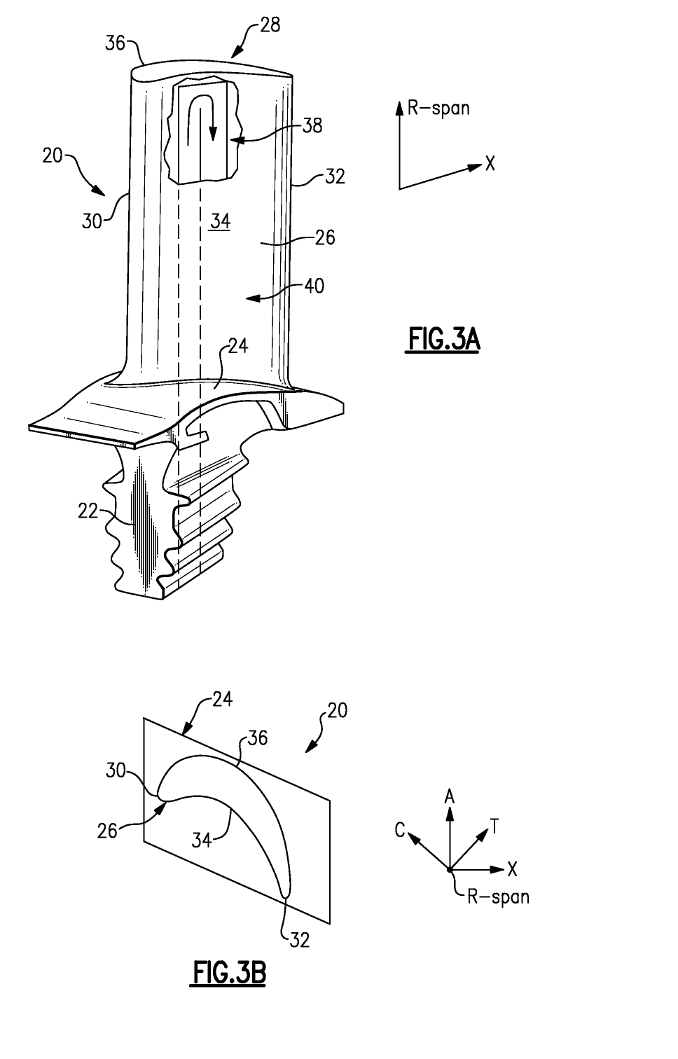

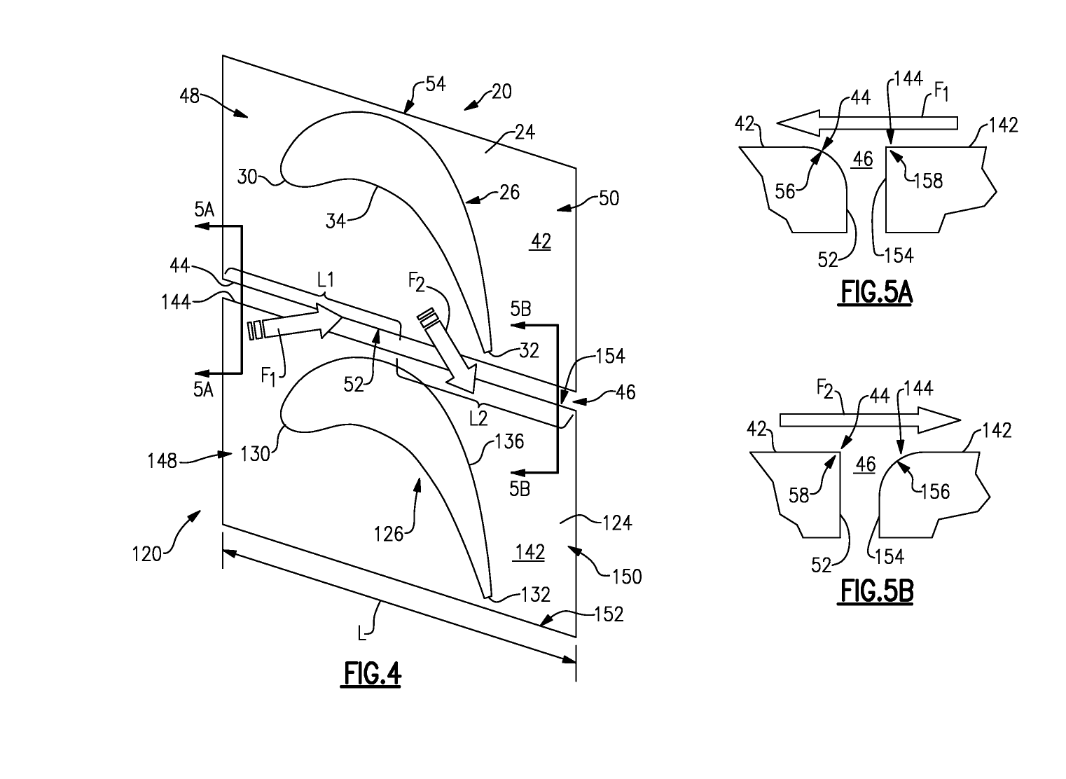

Many engine components, such as blade outer air seals (FIG. 2A at 100), vanes (singlet in FIG. 2B at 102, and doublet in FIG. 2C at 104) and blades (FIG. 3A at 20), includes endwalls that are arranged as an array of arcuate segments. Matefaces of adjacent endwalls are arranged next to one another and are exposed to the gases within the flow path. The disclosed mateface configuration may be used for any of these or other gas turbine engine components. For exemplary purposes, one type of turbine blade 20 is described in more detail below.

Referring to FIGS. 3A and 3B, a root 22 of each turbine blade 20 is mounted to a rotor disk, for example. The turbine blade 20 includes a platform 24, which provides the inner flowpath, supported by the root 22. An airfoil 26 extends in a radial direction R from the platform 24 to a tip 28. It should be understood that the turbine blades may be integrally formed with the rotor such that the roots are eliminated. In such a configuration, the platform is provided by the outer diameter of the rotor. The airfoil 26 provides leading and trailing edges 30, 32. The tip 28 is arranged adjacent to a blade outer air seal.

The airfoil 26 of FIG. 3B somewhat schematically illustrates exterior airfoil surface extending in a chord-wise direction C from a leading edge 30 to a trailing edge 32. The airfoil 26 is provided between pressure (typically concave) and suction (typically convex) wall 34, 36 in an airfoil thickness direction T, which is generally perpendicular to the chord-wise direction C. Multiple turbine blades 20 are arranged circumferentially in a circumferential direction A. The airfoil 26 extends from the platform 24 in the radial direction R, or spanwise, to the tip 28.

The airfoil 18 includes a cooling passage 38 provided between the pressure and suction walls 34, 36. The exterior airfoil surface 40 may include multiple film cooling holes (not shown) in fluid communication with the cooling passage 38.

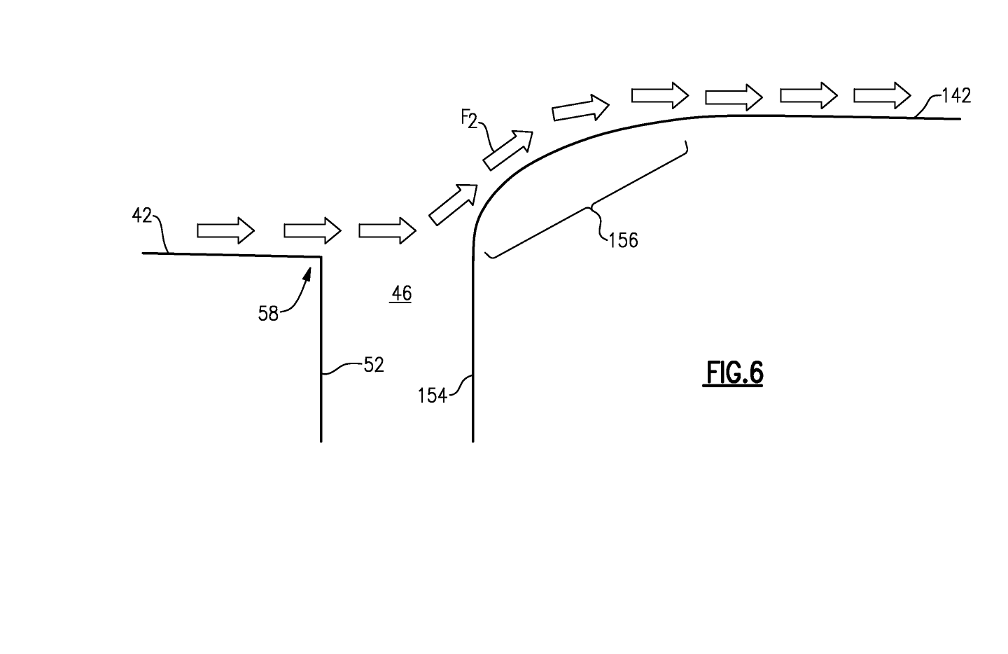

A pair of turbine blades 20, 120 is shown in FIG. 4. In the example, each turbine blade includes an airfoil 26, 126 extending from an endwall or platform that respectively provides first and second structures having surfaces 42, 142. The surfaces 42, 142 provide an inner flow path surface. Lateral edges 44, 144 are arranged adjacent to one another to provide a gap 46. First and second matefaces 52, 54 are arranged on opposing lateral sides of the blade 20, and first and second matefaces 152, 154 are arranged on opposing lateral sides of the blade 120. The first mateface 52 is perpendicular to the surface 42 along the second length L2, and the second mateface 154 is perpendicular to the surface 142 along the first length L1, which is best shown in FIGS. 5A and 5B.

Returning to FIG. 4, the gap 46 extends an axial length L that includes first and second lengths L1, L2. In the example, the first and second lengths L1, L2 are in a range of 30-70% of the axial length L. A flow through the core flow path passes over the gap 46 as fluid travels between the airfoils 26, 126.

The surfaces 42, 142 each have rounded edges 56, 156 arranged at the gap 46 in a staggered relationship relative to one another. The rounded edge 56 is arranged along the first length L1, and the rounded edge 156 is arranged along the second length L2. Sharp corners 58, 158 are provided respectively at the lateral edges 44, 144 adjacent to the rounded edges 56, 156. In one example, sharp corners are less than a 5 mil (0.13 mm) radius, and rounded edges are greater than 5 mils (0.13 mm).

Referring to FIGS. 4-5B, the rounded edge 56 is on a forward portion or end 48 of the surface 42 near the leading edge 30 and the pressure side 34. The surface 42 includes a generally sharp corner 58 on an aft portion or end 50 of the surface 42 near the trailing edge 32 and the pressure side 34. The rounded edge 156 is on the aft portion 150 of the surface 142 near the trailing edge 132 and the suction side 136. The surface 142 includes a generally sharp corner 158 on the forward portion 148 of the surface 142 near the leading edge 130 and the suction side 136.

The arrangement of rounded edges and sharp corners is such that a first flow F1 is oriented into the rounded edge 44 (FIG. 5A), and a second flow F2 is oriented into the rounded edge 144 (FIG. 5B). Thus, if the surfaces 42, 142 are misaligned with one another in the radial direction, as illustrated in FIG. 6, the flow will better transition over the surfaces 42, 142, thus avoiding high heat transfer coefficients. Sharp corners are provided on the upstream side of the gap 46 to avoid encouraging flow into the gap 46 and out of the core flow path.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. An array of components in a gas turbine engine, comprising:
first and second structures respectively include first and second surfaces that are arranged adjacent to one another to provide a gap, the first and second surfaces respectively have first and second rounded edges at the gap that are arranged in staggered relationship relative to one another.

2. The array according to claim 1, wherein the gap is provided at a constant angle along a generally axial length from a forward end of the first and second structures to an aft end of the first and second structures.

3. The array according to claim 2, wherein the axial length includes first and second lengths, the first and second lengths each in a range of 30-70% of the axial length, the first rounded edge arranged along the first length, and the second rounded edge arranged along the second length.

4. The array according to claim 3, wherein the first and second structures respectively include first and second matefaces facing one another at the gap, the first and second surfaces forming generally sharp corners respectively with the first and second matefaces adjacent to the first and second rounded edges, respectively.

5. The array according to claim 4, wherein the first and second surface and the first and second matefaces are respectively perpendicular to one another.

6. The array according to claim 1, wherein the first and second structures are one of a blade outer air seal or a platform.

7. The array according to claim 6, wherein the first and second structures are one of a stator vane or blade, and an airfoil extends radially from each of the first and second surfaces, each of the airfoils include pressure and suction sides joined at leading and trailing edges.

8. The array according to claim 7, wherein the first rounded edge is on a forward portion of the first surface near the leading edge and the pressure side, and the first surface includes a generally sharp corner on an aft portion of the first surface near the trailing edge and the pressure side.

9. The array according to claim 7, wherein the second rounded edge is on an aft portion of the second surface near the trailing edge and the suction side, and the second surface includes a generally sharp corner on a forward portion of the second surface near the leading edge and the suction side.

10. The array according to claim 7, comprising a flow path configured to be provided between the airfoils, the flow path configured to provide a first flow into the first rounded edge and a second flow into the second rounded edge.

11. The array according to claim 10, wherein the first and second surfaces are misaligned with one another in the radial direction.

12. A component in a gas turbine engine, comprising:
a structure that has a surface with a generally linear lateral edge, the lateral edge has a rounded edge along a first portion and a generally sharp corner along a second portion adjacent to the first portion.

13. The component according to claim 12, wherein the structure is one of a blade outer air seal or a platform.

14. The component according to claim 13, wherein the structure is one of a stator vane or blade, and an airfoil extends radially from the surface, the airfoil includes pressure and suction sides joined at leading and trailing edges.

15. The component according to claim 14, wherein the rounded edge is on a forward portion of the surface near the leading edge and the pressure side, and the surface includes a generally sharp corner on an aft portion of the surface near the trailing edge and the pressure side.

16. The component according to claim 14, wherein the rounded edge is on an aft portion of the surface near the trailing edge and the suction side, and the surface includes a generally sharp corner on a forward portion of the surface near the leading edge and the suction side.

17. The component according to claim 14, wherein a first rounded edge is on a forward portion of the surface near the leading edge and the pressure side, and the surface includes a generally sharp corner on an aft portion of the surface near the trailing edge and the pressure side, a second rounded edge is on an aft portion of the surface near the trailing edge and the suction side, and the surface includes a generally sharp corner on a forward portion of the surface near the leading edge and the suction side, and comprising a flow path configured to be provided on the surface, the flow path configured to provide a first flow into the first rounded edge and a second flow into the second rounded edge.

18. The component according to claim 12, wherein the structure includes matefaces transverse to the surface to provide the rounded edge and forming a sharp corner adjacent to the rounded edge.

19. The component according to claim 18, wherein the surface and the mateface are perpendicular to one another.
